(19) United States
(12) Patent Application Publication
(10) Pub. No.: US 2014/0108026 A1
(43) Pub. Date: Apr. 17, 2014

(54) AUTOMATIC CLINICAL TREATMENT DEVICE USAGE MONITORING

(71) Applicant: Brian Gale, Bronx, NY (US)

(72) Inventor: Brian Gale, Bronx, NY (US)

(21) Appl. No.: 13/830,843

(22) Filed: Mar. 14, 2013

Related U.S. Application Data
(60) Provisional application No. 61/611,261, filed on Mar. 15, 2012.

(51) Int. Cl. G06F 19/00

(52) U.S. Cl. CPC G06F 19/3481
USPC 705/2

(57) ABSTRACT

The invention is designed to prevent mis-administrations of radiation in therapy sessions. Because of the complexity of machine configurations and settings required for every radiation therapy protocol, the invention is also designed to confirm that the settings of radiation oncology treatment systems and devices accurately reflect the dose protocol as determined by the radiation oncologists. In the event of a discrepancy, the system is designed to prevent the operator from starting the treatment session.

### PRIORITY CLAIM

This application is a non-provisional continuation of U.S. Provisional Patent Application No. 61/611,261, filed on Mar. 15, 2012, which is herein incorporated by reference in its entirety. This application herein incorporates by reference U.S. patent application Ser. No. 12/905,980 filed on Oct. 15, 2010.

### BACKGROUND OF THE INVENTION

Modern delivery of radiation therapy involves the automatic setting of a large number of parameters on the treatment machine. This number can range from a few dozen for a simple treatment to several hundred for a complex treatment. An error in any one of these settings, either human-induced at the time of planning or computer-induced at the time of data transfer and download, can potentially lead to a catastrophic radiation event. However, for any given type of treatment for a particular disease the combination of these parameters share some strong similarities from patient to patient.

The invention is designed to prevent mis-administrations of radiation in therapy sessions. Because of the complexity of machine configurations and settings required for every radiation therapy protocol, the invention is also designed to confirm that the settings of radiation oncology treatment systems and devices accurately reflect the dose protocol as determined by the radiation oncologists. In the event of a discrepancy, the system is designed to prevent the operator from starting the treatment session.

### BRIEF DESCRIPTION OF THE DRAWINGS

FIG. 1: Flowchart for basic system check process.

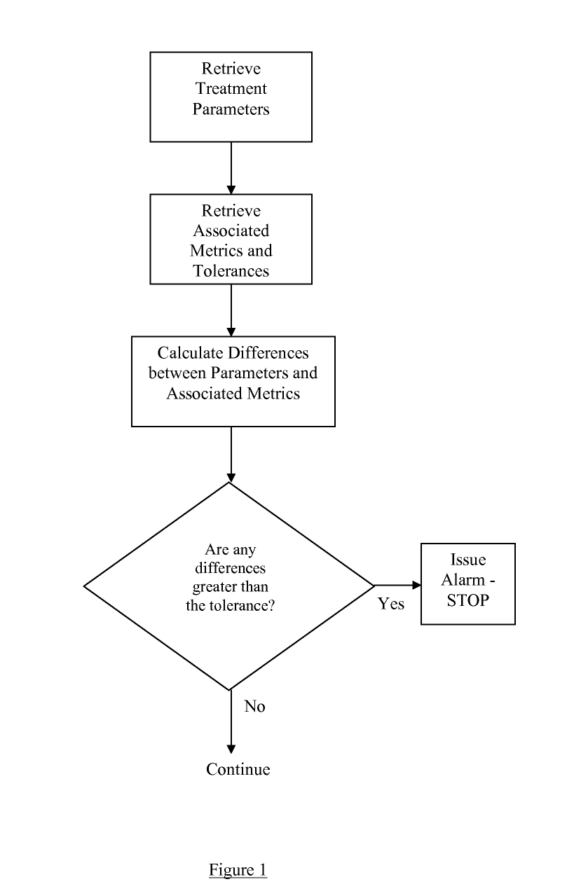

FIG. 2: Flowchart for determining thresholds for system alarm.

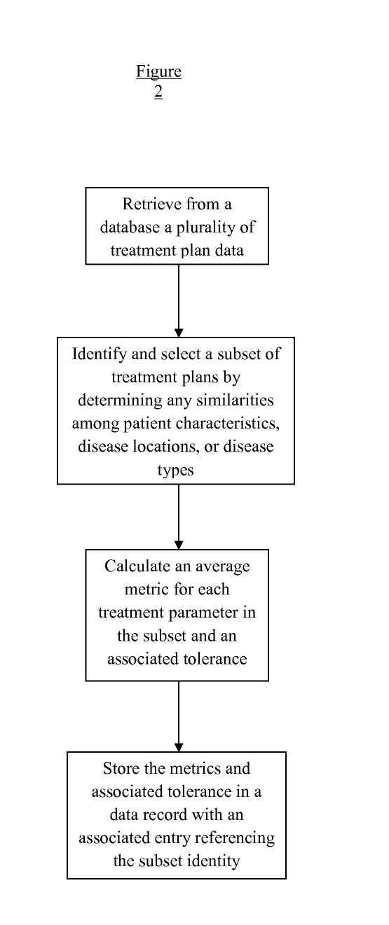

FIG. 3: Schematic of system architecture.

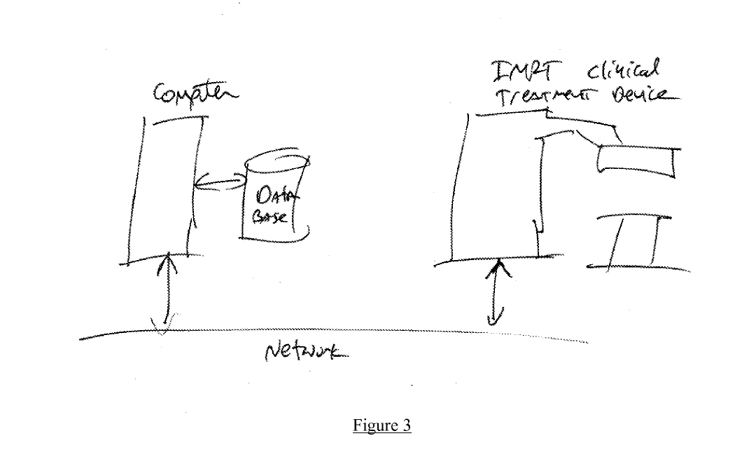

### DETAILED DESCRIPTION OF THE PREFERRED EMBODIMENTS

One embodiment of the invention is a computer system comprised of a software program that compares the combination of treatment parameters for a proposed treatment plan with that from historical data taken from patients previously treated for the same disease with the same type of treatment. The program will identify deviations from the historical data, prompting the user to verify that the deviation is not the result of an error that could lead to a catastrophic radiation event. The treatment plan is typically a data record containing component items that specify a plurality of beam dosages, that is, each treatment plan is a group of specified beams, each of a beam shape, beam angle or position, beam intensity and beam time.

The historical data for any radiation therapy modality, such as forward planning 3D conformal treatment for whole brain patients may be used. The goal of this analysis is to:

1. Identify which parameters or combinations of parameters share similarities among patients;

2. Identify which treatment parameters or combinations of parameters lead to a potentially catastrophic radiation event, should the setting be wrong;

3. Analyze what constitutes a deviation that can potentially lead to a catastrophic radiation event;

4. Create the mechanisms by which a deviation can be identified in a proposed treatment plan when comparing with historical data.

This invention relates to reducing the potential for catastrophic radiation or other error by using historical treatment data when automatically monitoring treatment plans or the operation of a clinical treatment device itself, including a radiation treatment delivery device. The increasing complexity of IMRT (Intensity Modulated Radiation Therapy) treatment plans requires carefully checking the correctness and consistency of an increasingly large number of treatment parameters between planning and each delivery session. A new level of safety can be added in the planning and delivery process by exploiting the similarities that exist among treatment parameters of a large pool of plans for the same disease using the same technique. The system includes a software program that analyzes either treatment plan data or clinical treatment device machine parameter distributions from historical treatment data for a given disease site and alerts the user or other party of any deviation. The system can alert treatment planning staff that a treatment plan is outside a calculated norm. The system can also stop or prevent the treatment if a difference between the treatment plan and the machine parameters is detected.

The distribution of treatment parameters for a population of 60 patients treated with whole brain irradiation using a forward planning technique with parallel opposed beams was analyzed. A total of 15 treatment parameters were considered, including the number of beams, beam energy, gantry, collimator and couch angles, SSD, field size, number of monitor units, number of monitor units (MU) per Gy at isocenter and beam weight. For each parameter, a range of acceptable values was extracted from the population distribution. A new plan was considered consistent with historical data if each of its parameter values was compatible with 60% of the population. In order to test the software, errors such as a wrong number of beams, beam energy, CT dataset or absence of heterogeneity correction were manually introduced in new plans.

As expected, the population of whole brain plans is very homogeneous. The SSD and number of MU per Gy exhibited a narrow Gaussian distribution. The field size, beam weight and number of MU show 2 Gaussian peaks corresponding to the open field and field-in-field, respectively. All other parameters had a single value. These narrow distributions made deviations easy to detect. The plans with the wrong number of beams or beam energy were easily detectable. The plan using the wrong CT dataset led to an SSD that was outside the historical range and was detected.

A computer system comprised of a software program can compare each new treatment plan to historical treatment parameters for the same disease. This has been successfully tested on a population of whole brain treatment plans. The use of such a program can detect potential errors that were accidentally introduced during data transfer and recording. In addition by using more standardized treatment approaches for a given disease, the risk for errors can be reduced.

The system is comprised of a computer operatively connected over a data network to a clinical treatment device. The device transmits data to the computer representing the parameter values describing the specific clinical treatment that has been delivered. The computer has access to a database that store the information and associates that information with the patient that was treated as well as other relevant data, including, the area of the body treated, patient height, weight, age, the disease type, tumor size, tumor location, tumor stage, time, location, the prescribing physician, the technician operating the device and any other relevant data. The database is updated with each treatment. The database is also used to either continuously or periodically calculate the average of a parameter value for all the patients or a defined subset of patients. The defined subset can be determined by running a range based search query to find patients of sufficiently similar height, weight, age, tumor location or any other aspect or combination. In addition, the database can receive and store such average data received from some other system that has a larger group to calculate an average for the parameters. Besides averaging, the system can calculate a mean or a weighted average. When the system is used, a set of parameters can be input into the computer to control the clinical device, or the clinical device can be directly controlled and the parameters retrieved by the system. The system can then check the parameters against the averages or other metrics to determine whether there is a potential error. If a discrepancy is detected, the system can issue a command to the clinical treatment device that prevents it from initiating the treatment and also it can issue an alarm to the technician. In one embodiment, the system and the clinical treatment device are distinct subsystems that communicate over a data network or other data interchange. In another embodiment, the system is integrated with the clinical treatment device. In one embodiment, the system operates by accessing the database over a data network. In another embodiment, the system and the database are integrated.

In an example embodiment a data structure is stored in the database that has several elements in each entry:
[location1, location2, angle, collimation, dosage threshold].

As an example, the location may be specified as “cervical 3”, “posterior”, and the angle “zero degrees”. However, this point into the spinal column and therefore the dosage threshold would be a low number to avoid damaging the spinal cord. However, if the angle entry was “90 degrees”, the dosage threshold entry may be higher. In some IMRT systems, the dosage is a list of angles, collimations and dosage amounts that are delivered to the patient in each session. In this case, the entries in the IMRT instructions can be matched against the database contents in the following manner: for each entry in the IMRT prescription list, the geometry defined by the instruction is checked against the list of dosage limits to determine whether any of the geometries in the listed instructions are within the spatial geometry defined by any of the dosage limit entries. Where that is the case, the dosage in the instructions is checked against the dosage limit. In other embodiments, the IMRT instructions are not provided in terms of patient anatomy, but rather the actual measured position to references on the patient's body. This increases the accuracy of the positioning of IMRT, but introduces a problem: not all patients have identical size. In this case, the IMRT instructions are mapped to a nominal model of the shape of a human body. For example, a size ratio in one or more dimensions may be specified that maps the actual patient to the nominal patient model. The safety limit list can then refer to the nominal patient model geometric locations. In this embodiment, the IMRT instruction list for the patient is converted to a list of instructions where the geometries have been scaled with the ratios, in order that IMRT instructions are mapped to the nominal patient body. Then the list of instructions can be compared to the safety list that refers to geometric positions of the nominal patient body.

### Operating Environment:

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a firewall proxy to one server, which routes communications to another server that executes the disclosed methods. The precise details of the data network architecture do not limit the claimed invention. Further, the user's computer may be a laptop or desktop type of personal computer. It can also be a video game console, a cell phone, smart phone or other handheld device. The precise form factor of the user's computer does not limit the claimed invention. In one embodiment, the user's computer is omitted, and instead a separate computing functionality provided that works with the central server. In this case, a user would log into the server from another computer and access the simulated space. In another embodiment, the user can operate a local computer running a browser, which receives from a central server a video stream representing the rendering of the simulated space from the point of view associated with the user.

Further, the user may receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. A server may be a virtual server, where one or more virtual servers are individual instances of software operating as independent servers but housed in the same computer hardware device. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The IO devices can include a display screen, loudspeakers, microphone and a movable mouse that indicate to the computer the relative location of a cursor position on the display and one or more buttons that can be actuated to indicate a command.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The computer can operate a program that receives from a remote server a data file that is passed to a program that interprets the data in the data file and commands the display device to present particular text, images, video, audio and other objects. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location. The HTML can also have references that result in other code modules being called up and executed, for example, Flash or other native code.

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity. In one embodiment different regions of the simulated space have different URL's. That is, the simulated space can be a unitary data structure, but different URL's reference different locations in the data structure. This makes it possible to simulate a large area and have participants begin to use it within their virtual neighborhood.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as C, C++, C#, Action Script, PHP, EcmaScript, JavaScript, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the relational database (I will use cloud storage services such as Amazon SimpleDB, this is most often not relational DB but Column-oriented/NoSQL DB) may be housed in one or more operatively connected servers operatively connected to computer memory, for example, disk drives. The invention may be executed on another computer that is presenting a user a semantic web representation of available data. That second computer can execute the invention by communicating with the set of servers that house the relational database. In yet another embodiment, the initialization of the relational database may be prepared on the set of servers and the interaction with the user's computer occurs at a different place in the overall process.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

What is claimed:

1. A method executed by a computer system of preventing errors in treatment delivery by a clinical treatment device comprising:
receiving parameters from the clinical treatment device operatively connected to the computer system, said parameters controlling the specific treatment or dosage for a specific patient being treated;
retrieving from a database a set of safety parameters relevant to the treatment being delivered;
calculating differences between received parameters and the set of safety parameters retrieved from the database;
determining if one or more of the calculated differences are greater than a predetermined tolerance threshold value; and
transmitting either a stop command to the clinical device to prevent the treatment or an alarm message in the event that the determination step detects a difference greater than the predetermined tolerance threshold value.

2. A method executed by a computer system of preventing errors in treatment delivery by a clinical treatment device comprising:
retrieving from a database one or more parameters comprising a treatment plan;
retrieving from a database a set of safety parameters relevant to the treatment plan, said safety parameters derived from a plurality of similar treatment plans, said safety parameters comprised of one or more predetermined tolerance threshold values, each tolerance associated with a dosage value;
calculating differences between the retrieved parameters and the set of safety parameters;
determining if one or more of the calculated differences are greater than a corresponding predetermined tolerance threshold value; and
transmitting a data message representing an alarm message in the event that the determination step detects a difference greater than the predetermined tolerance threshold value.

3. A method executed by a computer system of preventing errors in treatment delivery by a clinical treatment device comprising:
receiving parameters from the clinical treatment device operatively connected to the computer system, said parameters controlling the specific treatment or dosage for a specific patient being treated;
retrieving from a database the parameters comprising the treatment plan data package describing the treatment being delivered;
calculating differences between received parameters and the set of retrieved parameters; and
determining if the absolute value of one or more of the calculated differences is greater than a predetermined threshold;
transmitting either a stop command to the clinical device to prevent the treatment or an alarm message in the event that the determination step detects an absolute value of the difference greater than the predetermined threshold.

4. The method of claim 1 or 2 further comprising:
extracting a geometric parameter from the received parameters;
extracting a corresponding geometric parameter range from the safety parameters; and
determining whether the geometric parameter specified by the received parameters lies within a geometric parameter range specified by the safety parameters.

5. A system for preventing errors in treatment delivery by a clinical treatment device comprising:
a component adapted to receive parameters from the clinical treatment device operatively connected to the computer system, said parameters controlling the specific treatment or dosage for a specific patient being treated;
a component adapted to retrieve from a database a set of metrics relevant to the treatment being delivered;
a component adapted to calculate differences between received parameters and the set of metrics retrieved from the database;
a component adapted to determine if one or more of the calculated differences are greater than a predetermined tolerance threshold value; and
a component adapted to transmit either a stop command to the clinical device to prevent the treatment or an alarm message in the event that the determination step detects a difference greater than the predetermined tolerance threshold value.

6. A system for preventing errors in treatment delivery by a clinical treatment device comprising:
a component adapted to retrieve from a database one or more parameters comprising a treatment plan;
a component adapted to retrieve from a database a set of metrics relevant to the treatment plan, said metrics derived from a plurality of similar treatment plans, said metrics including one or more predetermined tolerance threshold values, each tolerance associated with a metric;
a component adapted to calculate differences between retrieved parameters and the set of metrics;
a component adapted to determine if one or more of the calculated differences are greater than an associated predetermined tolerance threshold value; and
a component adapted to transmit a data message representing an alarm message in the event that the determination step detects a difference greater than the predetermined tolerance threshold value.

7. A system for preventing errors in treatment delivery by a clinical treatment device comprising:
a component adapted to receive parameters from the clinical treatment device operatively connected to the computer system, said parameters controlling the specific treatment or dosage for a specific patient being treated;
a component adapted to retrieve from a database the parameters comprising the treatment plan data package describing the treatment being delivered;
a component adapted to calculate differences between received parameters and the set of retrieved parameters;
a component adapted to determine if the absolute value of one or more of the calculated differences is greater than a predetermined threshold; and
a component adapted to transmit either a stop command to the clinical device to prevent the treatment or an alarm message in the event that the determination step detects an absolute value of the difference greater than the predetermined threshold.

8. The system of claim 5 or 6 further comprising:
a component adapted to extract a geometric parameter from the received parameters;
extract a corresponding geometric parameter range from the safety parameters; and
determine whether the geometric parameter specified by the received parameters lies within a geometric parameter range specified by the safety parameters.
